(19) United States
(12) Patent Application Publication
(10) Pub. No.: US 2017/0327076 A1
(43) Pub. Date: Nov. 16, 2017

(54) Seatbelt Adjuster

(71) Applicant: Earl Eugene Bennett, Worthville, KY (US)

(72) Inventor: Earl Eugene Bennett, Worthville, KY (US)

(21) Appl. No.: 15/155,593

(22) Filed: May 16, 2016

(51) Int. Cl. B60R 22/30; A44B 11/25; B60R 22/12

(52) U.S. Cl. CPC B60R 22/30; B60R 22/12; A44B 11/2507; A44B 11/2561

(57) ABSTRACT

The present invention is a a seatbelt adjuster arm that extends a standard seatbelt for more comfort while providing the same amount of safety. It is a seatbelt adjuster arm comprising a tongue attached to a belt which has a latch plate at the other end. The tongue of the seatbelt adjuster arm will clip into the latch of the seatbelt of the vehicle seat that the user is going to seat in. The tongue of the standard seatbelt of the vehicle extending the seatbelt moving it several inches from the user's neck.

CROSS-REFERENCES TO RELATED APPLICATIONS (IF ANY)

None

### BACKGROUND

### 1. Field of the Invention

The present invention relates to a Seatbelt Adjuster in particular one that is design to extend the length of a seat belt for comfort.

### 2. Description of Prior Art

Many people have a problem of seatbelts. There is the age-old problem of the seatbelt rubbing and hurting their necks. With so many different cars and so many different body types out there, an ordinary seatbelt can cause strain on the neck of not only larger people but smaller people as well.

There exists a need to make the standard seatbelts of a vehicle better fit and wear better while still offering protection. There is still room for improvement in the art.

### SUMMARY OF THE INVENTION

The present invention is a device that allows the user to extend a standard seatbelt for more comfort while providing the same amount of safety. It is a seatbelt adjuster arm comprised a tongue (male connector) attached to a belt which has a latch plate (female end) at the other end. The latch plate has a seatbelt latch plate cover with a top and a bottom, a spring lock assembly and release button.

The seatbelt adjuster arm tongue and latch plate will be available in all the standard seatbelt sizes.

The tongue of the seatbelt adjuster arm will clip into the latch of the seatbelt of the vehicle seat that the user is going to seat in. The tongue of the standard seatbelt of the vehicle will clip into latch of the seatbelt adjuster arm extending the seatbelt and moving it several inches from the user's neck.

The current invention is more comfortable and functional than the current art.

### BRIEF DESCRIPTION OF THE DRAWINGS

Without restricting the full scope of this invention, the preferred form of this invention is illustrated in the following drawings:

FIG. 1 displays the seatbelt adjuster arm and its components;

FIG. 2 displays the seatbelt adjuster with different widths to match existing seatbelts;

FIG. 3 displays the seatbelt adjuster being attached to the vehicle's seatbelt; and

FIG. 4 displays the seatbelt adjusters being used by a user.

### DESCRIPTION OF THE PREFERRED EMBODIMENT

There are a number of significant design features and improvements incorporated within the invention.

The present invention is a seatbelt adjuster arm 1. It is a device that allows the user 50 to extend a standard seatbelt for more comfort while providing the same amount of safety.

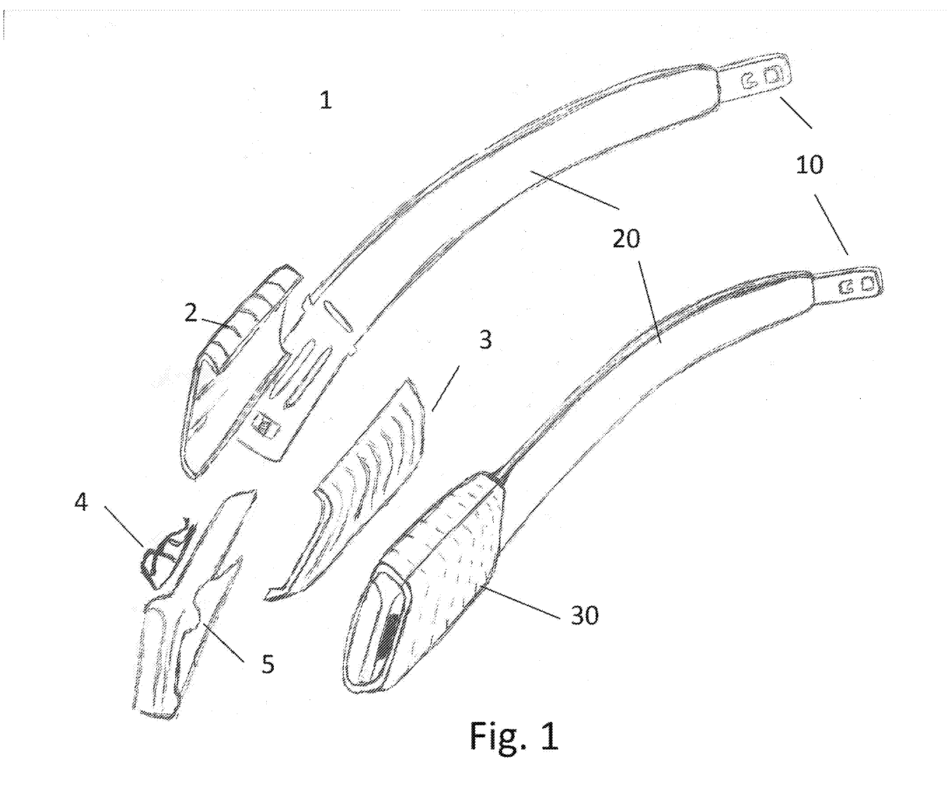

As shown in FIG. 1, the seatbelt adjuster arm 1 is comprised of a tongue (male connector) 10 attached to a belt 20 which has a latch plate (female end) 30 at the other end. The latch plate 30 has a seatbelt latch plate cover with a top 2 and a bottom 3, a spring lock assembly 5 and release button 4.

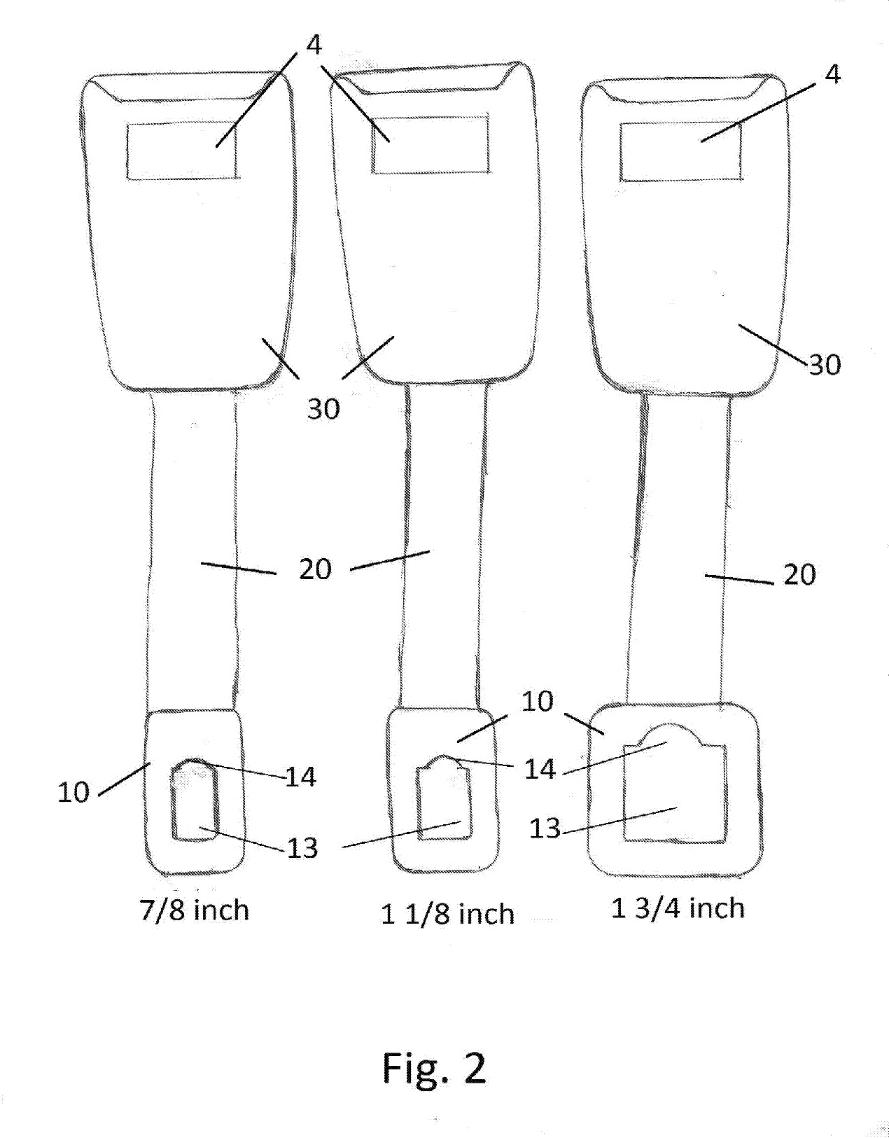

The seatbelt adjuster arm 1 tongue 10 and latch plate 30 will be available in all the standard seatbelt sizes as shown in FIG. 2. This will allow the user to use the seatbelt adjuster arm 1 with any vehicle seatbelt. As shown in FIG. 2, the tongue 10 has a latch opening 13 in the middle of it. The latch opening 13 is where the latch of the latch plate 30 goes into to secure the seat belt. It is rectangular in shape with an arch 14 at the top of the rectangle.

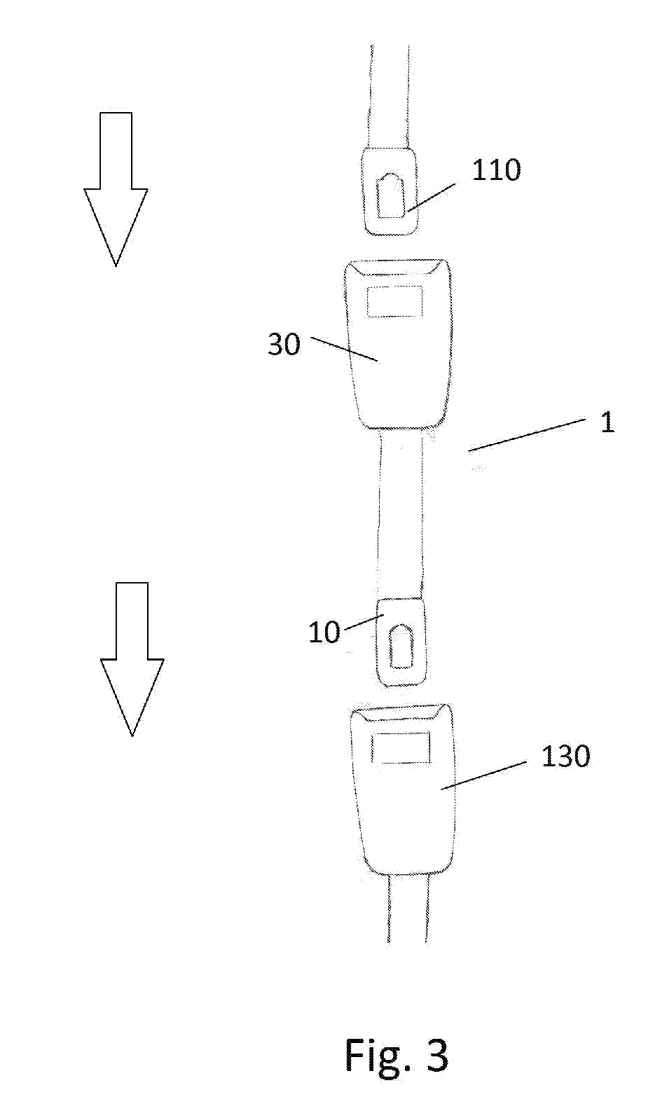

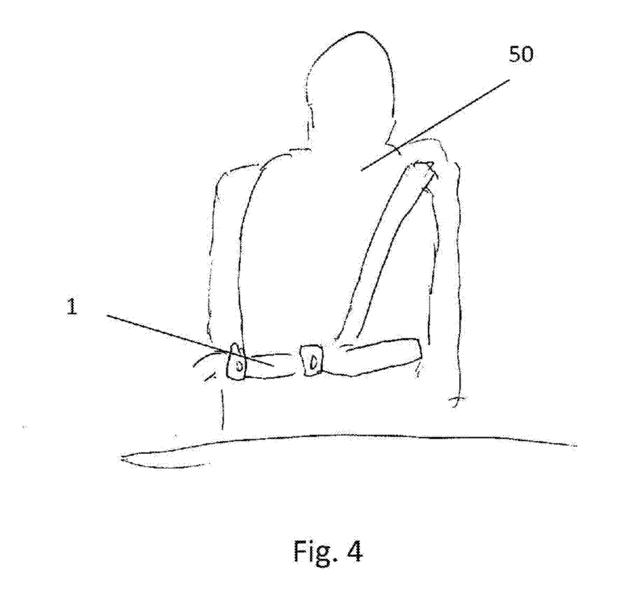

As shown in FIG. 3, the tongue 10 of the seatbelt adjuster arm 1 will clip into the latch 130 of the seatbelt of the vehicle seat that the user 40 is going to seat in. The tongue 110 of the standard seatbelt of the vehicle goes into the latch 30 of the seatbelt adjuster arm 1 extending the seatbelt moving it several inches from the user's neck. The seatbelt adjuster arm 1 being used by the user 40 is shown in FIG. 4. The seatbelt adjuster arm 1 is ergonomically designed.

The belt 20 is made of a flexible sturdy material just like the seatbelt in a vehicle.

The seatbelt adjuster arm 1 allows the user 50 to buckle up safely while providing more comfort. Simply clicks on to existing seat belt assembly, no tools are required. It is easy to change from vehicle to vehicle.

The device 1 converts the Type II to Type III restraint system which eliminates/reduces injuries in the event of impact. Its unique design keeps pressure off the body until restraint is required

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A seatbelt adjuster arm device comprising:
a belt with a tongue with a latch opening that is rectangular in shape with an arch at the top of the rectangle attached on one end with a latch plate attached at the other end.

2. A device according to claim 1 further comprising the latch plate having a seatbelt latch plate cover with a top and a bottom, a spring lock assembly and release button.

3. A device according to claim 1 further comprising having the tongue of the seatbelt adjuster arm clip into a latch of a seat belt.

4. A device according to claim 1 further comprising having the tongue of a seatbelt fit into a latch of the seat belt extender arm.

5. A device according to claim 1 further comprising having seatbelt adjuster arm made of a flexible sturdy material.

6. A device according to claim 1 further comprising having seatbelt adjuster arm be ergonomically designed.

7. A seatbelt adjuster device comprising:
a belt with a tongue with a latch opening that is rectangular in shape with an arch at the top of the rectangle attached on one end with a latch plate attached at the other end where the latch plate having a seatbelt latch plate cover with a top and a bottom, a spring lock assembly and release button.

8. A device according to claim 7 further comprising having the tongue of the seatbelt adjuster clip into a latch of a seat belt.

9. A device according to claim 7 further comprising having the tongue of a seatbelt fit into a latch of the seat belt extender.

10. A device according to claim 7 further comprising having seatbelt adjuster made of a flexible sturdy material

11. A device according to claim 7 further comprising having seatbelt adjuster arm be ergonomically designed.
